(19) United States
(12) Patent Application Publication
(10) Pub. No.: US 2003/0226131 A1
(43) Pub. Date: Dec. 4, 2003

(54) Method for semantic verification of supporting programming artefacts

(75) Inventor: Jin Li, Toronto (CA)

Correspondence Address: Cynthia S. Byrd, International Business Machines, Intellectual Property Law, 11400 Burnet Road, Austin, TX, 78758, US

(73) Assignee: INTERNATIONAL BUSINESS MACHINES CORPORATION, ARMONK, NY

(21) Appl. No.: 10/285,989

(22) Filed: Oct. 31, 2002

(30) Foreign Application Priority Data
May 29, 2002 (CA) 2,388,073

(51) Int. Cl. G06F 9/44; G06F 9/45

(52) U.S. Cl. 717/110; 717/143

(57) ABSTRACT

A semantic verification feature of a programmer editor in a software development tool provides semantic verification of supporting programming artefacts. Such supporting programming artefacts program documentation and output messages. The semantic verification may include spell-checking, grammar checking and checking that the supporting programming artefacts adhere to company policies related to format and structure. Additionally, the feature may isolate and identify an inconsistency between documentation comments and program code.

### FIELD OF THE INVENTION

The present invention relates to code-editing programs used by programmers and, in particular, to semantic verification of supporting programming artefacts.

### BACKGROUND OF THE INVENTION

Programmer editors, that is, text editors specifically designed for use by programmers for developing program code, have traditionally provided semantic verification of program code under development. Such semantic verification provides support for syntax checking and highlighting any syntax errors found in the code created by the programmer. For instance, such a programmer editor may recognize that a programmer is attempting to insert a call to a method from an application programming interface (API) that does not exist. Upon recognizing that the inserted method is unknown, the programmer editor may highlight the unknown method to bring the unknown method to the attention of the programmer. Such highlighting can allow the programmer to correct the error before the code is saved and compiled. The unknown method would also be flagged by the compiler, but, by flagging the unknown method during editing, it is understood that there is some savings in development time.

Such programmer editors are arranged to perform this so-called semantic verification on the program code, as distinguished from program documentation and output messages. The program code must adhere to a small set of rules defined by the language being used to develop the code. While program documentation and output messages are typically not confined to the same programming-language specific syntax rules, they are still best understood if they adhere to language specific syntax, i.e., the basic rules (spelling, grammar) of the communication language, for instance, English, being used to document the program code. Unfortunately, mistakes can be made just as easily in program documentation and output messages, known collectively as supporting programming artefacts, as they can be made in program code. It should be noted that program documentation and output messages can be critical factors in a successful software product.

The importance of spelling and grammar verification for supporting programming artefacts is increasing, due to the introduction of automated program document production mechanisms. Javadoc is a tool from Sun Microsystems, of Palo Alto, Calif., for generating API documentation in Hyper-Text Markup Language (HTML) format from documentation comments in source code. The programmer surrounds documentation comments with delimiters (e.g., /** documentation comment*/) so that the Javadoc tool can distinguish the documentation comments from the code to be compiled. The Javadoc tool receives, as input, a text file of program code with associated supporting programming artefacts and outputs a file wherein the documentation comments have been formatted in HTML.

### SUMMARY OF THE INVENTION

A feature for programmer editors is used to perform semantic verification of supporting programming artefacts. The supporting programming artefacts may include program documentation and output messages and the semantic verification may include spell-checking, grammar checking, format checking and identification of inconsistencies between documentation and program code.

Advantageously, the feature may assist in ensuring that program documentation is synchronized with associated program code, ensuring program documentation and output messages are grammatically correct and providing a mechanism for implementing and enforcing a company-wide format for program documentation and output messages.

In accordance with an aspect of the present invention there is provided a method of providing a semantic verification feature in an editor for program code. The method includes recognizing a supporting programming artefact, verifying semantics of the supporting programming artefact and, where the semantics of the supporting programming artefact are in error, emphasizing a display of the supporting programming artefact. In another aspect of the present invention there is provided a software development tool including an editor with a semantic verification feature operable to carry out this method. In a further aspect of the present invention, there is provided a system for software development including a processor adapted to perform this method. Additionally, there is provided a computer readable medium for allowing a general-purpose computer to perform this method.

In accordance with another aspect of the present invention there is provided a method of operating a program code editor. The method includes receiving an instruction to save a text file containing program code and supporting programming artefacts and, responsive to receiving the instruction, initiating a semantic verification of the supporting programming artefacts.

Other aspects and features of the present invention will become apparent to those of ordinary skill in the art upon review of the following description of specific embodiments of the invention in conjunction with the accompanying figures.

### BRIEF DESCRIPTION OF THE DRAWINGS

In the figures which illustrate example embodiments of this invention:

FIG. 1 illustrates a software development system;

FIG. 2 illustrates a window in a programmer editor, showing a source file of exemplary program code under development;

FIG. 3 illustrates a window showing the exemplary program code of the source file of FIG. 2 where the programmer editor employs a semantic verification feature according to an embodiment of the present invention;

FIG. 4 illustrates the window of FIG. 3 after the source file has been saved, according to an embodiment of the present invention;

FIG. 5 illustrates the window of FIG. 4 after the program code has been changed;

FIG. 6 illustrates the window of FIG. 5 after the source file has been saved, according to an embodiment of the present invention;

FIG. 7 illustrates, in a flow diagram, steps of an input monitoring method exemplary of a feature of a programmer editor according to an embodiment of the present invention;

FIG. 8 illustrates, in a flow diagram, steps of a file saving verification method exemplary of a feature of a programmer editor according to an embodiment of the present invention; and

FIG. 9 illustrates, in a flow diagram, steps of a semantic verification method exemplary of a feature of a programmer editor according to an embodiment of the present invention.

### DETAILED DESCRIPTION

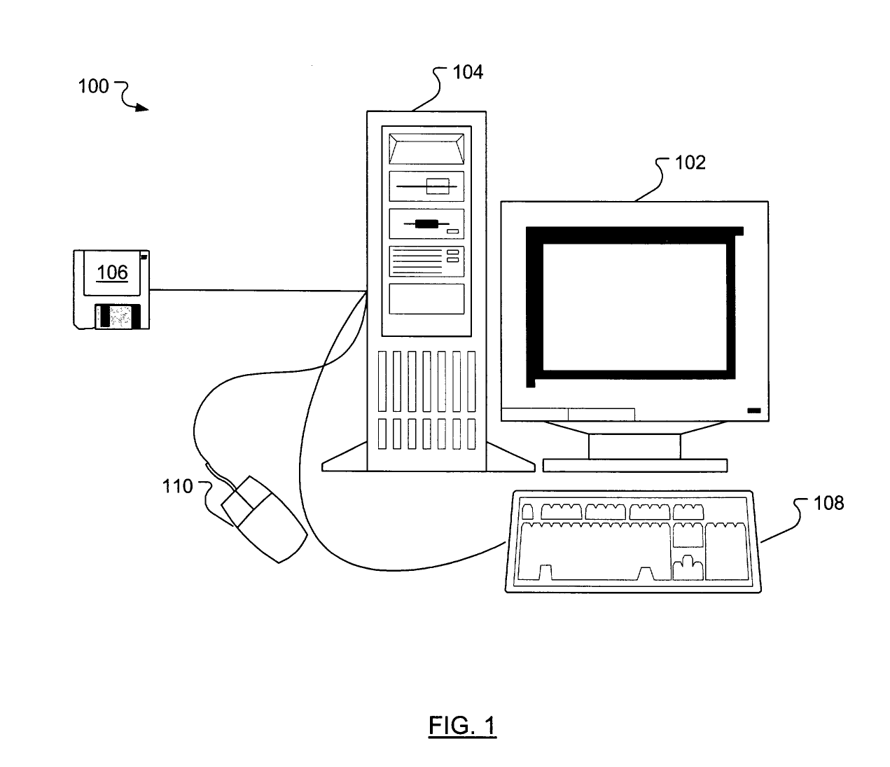

A software development system 100, capable of semantic verification according to methods exemplary of the present invention, is illustrated in FIG. 1. The software development system 100 includes a display monitor 102 and a central processing unit 104. The central processing unit 104 may include hardware to network with other computers, long-term and short-term memory and a processor. As is typical, connected to the central processing unit 104 may be multiple input peripherals such as a keyboard 108 and a mouse 110. The software development system 100 may be loaded with a software development tool for executing methods exemplary of this invention from a software medium 106 which could be a disk, a tape, a chip or a random access memory containing a file downloaded from a remote source.

In overview, a feature is added to programmer editors that allows semantic verification of supporting programming artefacts. Semantic errors are emphasized so that the errors may be brought to the attention of the programmer creating the code and the errors may be subsequently corrected.

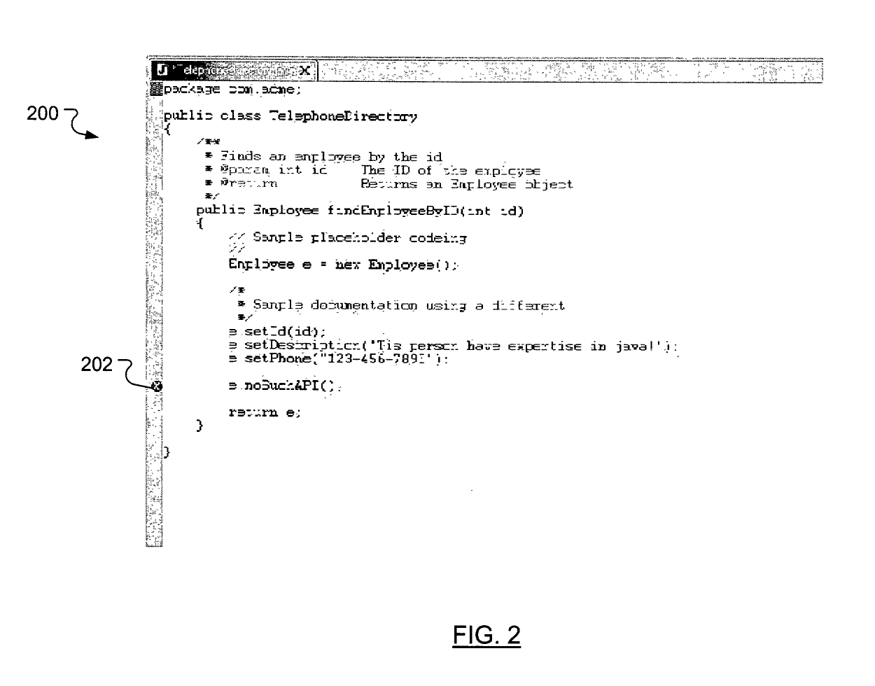

In present programmer editors, typically only program code syntax is verified. This verification can lead to errors and warnings being flagged. FIG. 2 illustrates a window 200 in a programmer editor, showing a source file of exemplary program code under development. The exemplary program code has been chosen to deliberately include a syntax error in the form of a nonexistent API method, named “noSuchAPI”. The programmer editor, acting as is known, has identified the API method as nonexistent and displays an error icon 202 in the left margin of the window 200 to alert the programmer to the syntax error.

Further errors are deliberately included in the exemplary program code. For instance, spelling errors (“codeing”, “Tis”) and grammatical errors (“using a different”, “person have”) are included in the program documentation and output messages. In addition, structural errors are included. By convention, the word “java” should be capitalized and, perhaps, the phone number format should be (123) 456-7890 instead of 123-456-7890 according to a company-wide policy.

Typical programmer editors are not arranged to flag these errors. In fact, by recognising delimiters that identify program documentation (/I* . . . */) and output messages (“. . . ”), typical programmer editors specifically avoid semantic verification of supporting programming artefacts.

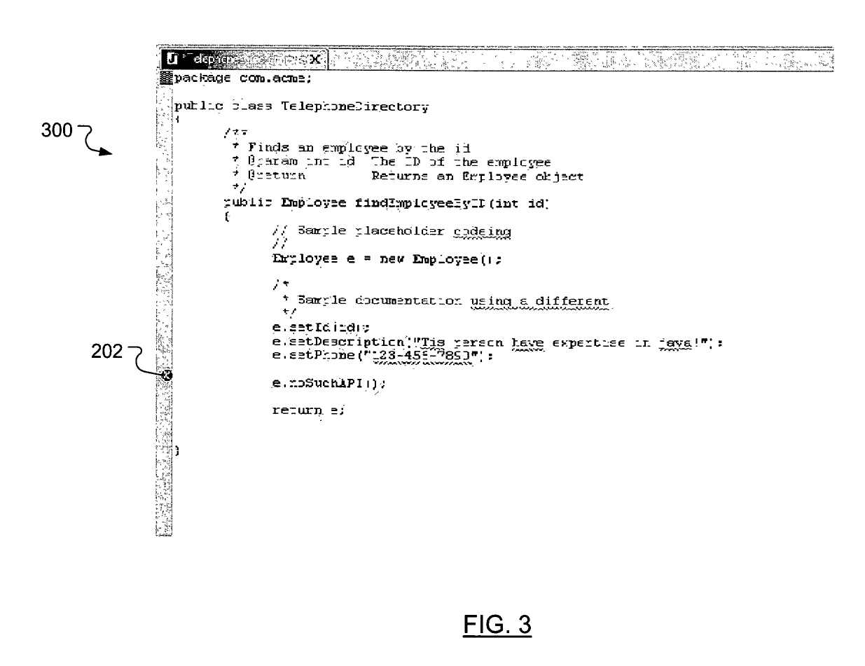

The same exemplary program code is shown in a window 300 in FIG. 3 where the programmer editor employs a feature exemplary of aspects of the present invention and the feature performs semantic verification of supporting programming artefacts. In the window 300 of FIG. 3, each of the deliberately included syntax errors identified above has been emphasized to bring the syntax errors to the attention of the programmer. In FIG. 3, the structure, spelling and grammar errors are emphasized using a common indicator known as a “squiggle”. A programmer editing the exemplary program code then has the opportunity to correct the syntax errors manually before saving the changes to the source file.

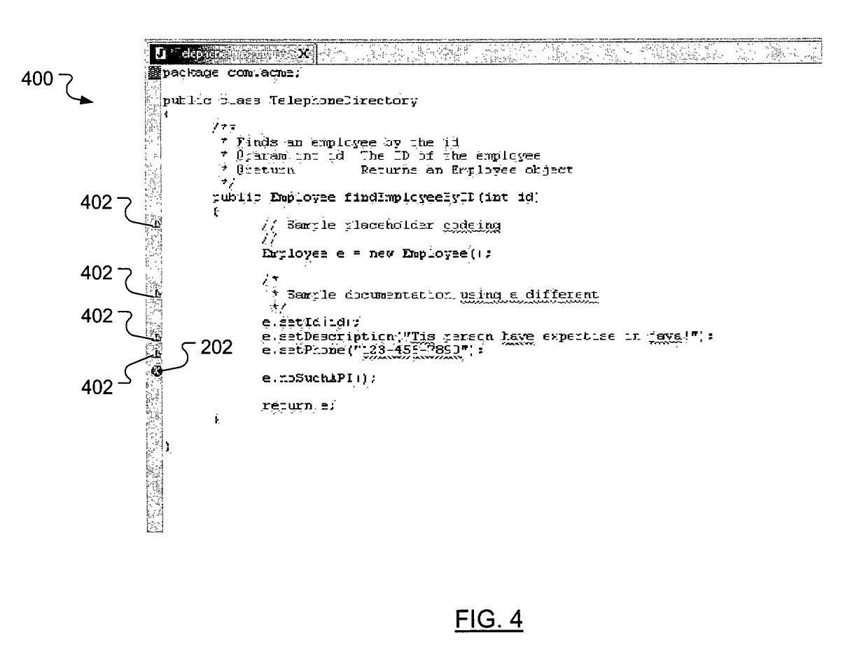

If the source file is saved before the syntax errors are corrected, the feature of the programmer editor can provide further error indications. A window 400 is illustrated in FIG. 4 to demonstrate an implementation of this further error indication. In the window 400 of FIG. 4, a warning icon 402 is displayed in the left margin horizontally even with each of the lines on which syntax errors have been identified by the feature of the programmer editor. Such a display in the left margin should be familiar to the programmer as the left margin is commonly used to display icons in semantic verification of the executable program code (see FIG. 2).

The warning icons in the left margin of the editor window 400 visually remind programmers that there are syntax errors in the supporting programming artefacts. In one implementation of the present invention, as a feature in a programmer editor, it is expected that the identified syntax errors in the supporting programming artefacts will each be flagged with a warning icon (e.g., a yellow triangle housing a black exclamation mark). Further, it is expected that the identification of syntax errors in the supporting programming artefacts does not affect the successful compilation and execution of the core program code.

However, syntax errors can, either individually or based on an error-type category, be configured to be identified by an error icon (e.g., a red circle housing a white “x”). Additionally, the semantic verification feature of a programmer editor can be configured to prevent the program code from successful compilation until those syntax errors identified by an error icon are corrected.

Often programmers modify and update program code without updating the corresponding program documentation, because the programmers either forget to update or they put off updating and eventually forget about it.

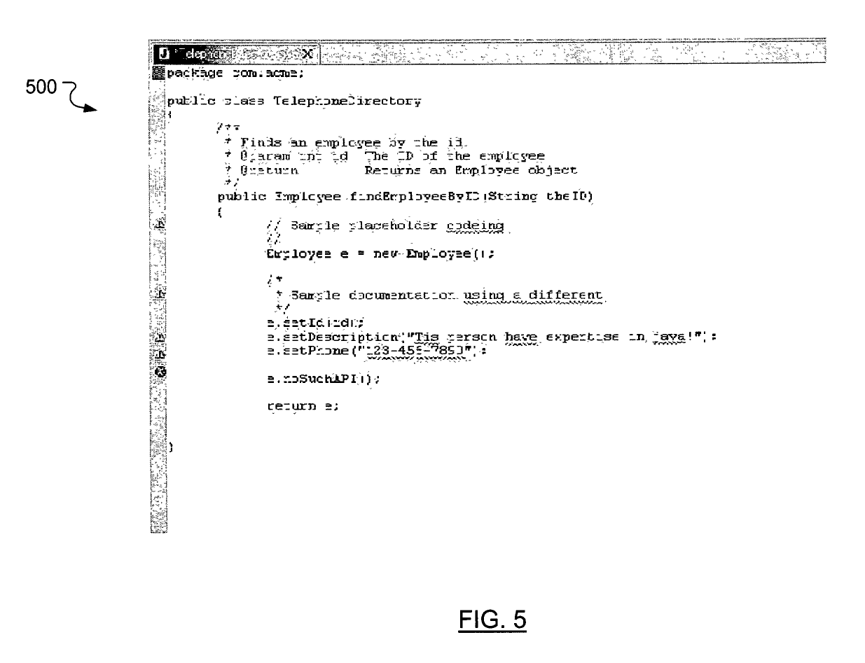

FIG. 5 illustrates a window 500 of the programmer editor in which program code and documentation comments have become “out of sync” (out of synchronization). In the particular case of the exemplary program code of FIG. 5, the signature of the method “findEmployeeByID” has been changed such that the method now takes “String theID” as a parameter, rather than “int id”. However, the documentation comments (encapsulated by /**and*/ for the benefit of Javadoc) are not updated to reflect the change. This failure to update the documentation comments can cause significant problems. Other programmers often rely on the automatically generated API documentation to develop program code for an application that will use this API. A different data type in the documentation comments and the actual implementation (program code) can lead to “bugs” that may be difficult to find and correct.

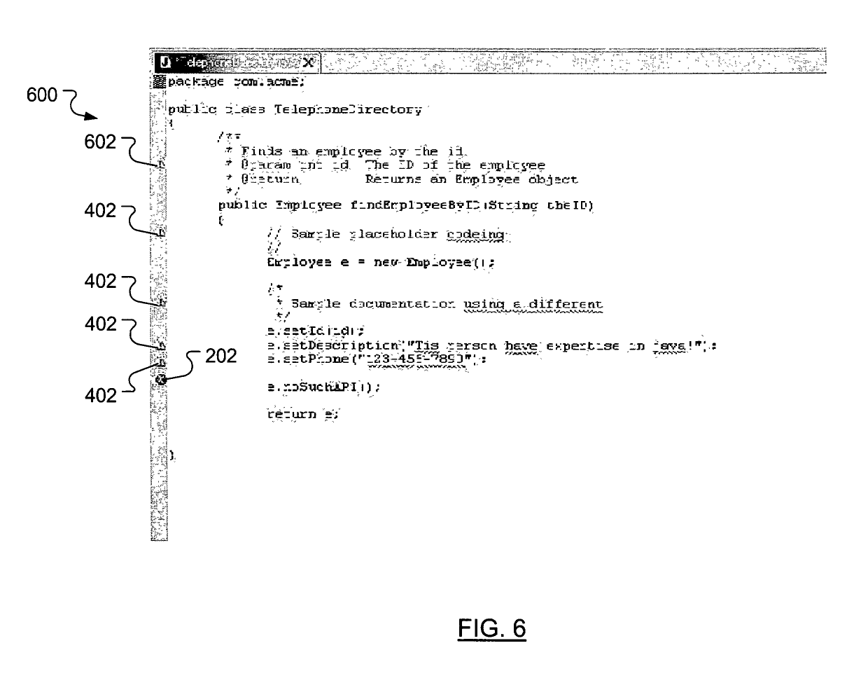

Through semantic verification of supporting programming artefacts, such a failure to update the documentation comments after a change in the program code may be recognized and brought to the attention of the programmer. FIG. 6 illustrates a window 600 of the programmer editor showing the exemplary program code of FIG. 5 after the source file has been saved. Notably, the semantic verification feature of the programmer editor has indicated the inconsistency between the documentation comments and the program code by placing a warning icon 602 in the left margin.

Alternatively, a predefined configuration of the feature may have provided that the severity of such an inconsistency was to be identified by an error icon rather than the warning icon 602. The predefined configuration may assist the programmer editor to distinguish errors by first classifying a given error and then assigning an icon based on a correspondence between a class of error and a severity of icon. Errors may be classified as, for example, format error, grammar error, spelling error or inconsistency with code error. It may be established in the predefined configuration that the format and grammar errors have a “low” severity, corresponding to a warning icon, and that the spelling and inconsistency errors have a “high” severity, corresponding to an error icon.

In review, typical programmer editors distinguish between text that is representative of program code and text that is representative of supporting programming artefacts. The typical programmer editor then performs semantic verification only on the program code. In contrast, a programming editor employing an aspect of the present invention makes the same distinction and then performs a semantic verification of the text, with the semantic rules determined by the distinction made. That is, where the text is determined to be program code, semantic verification is performed on the text using program code semantic rules and where the text is determined to be representative of supporting programming artefacts, semantic verification is performed on the text using semantic rules related to supporting programming artefacts.

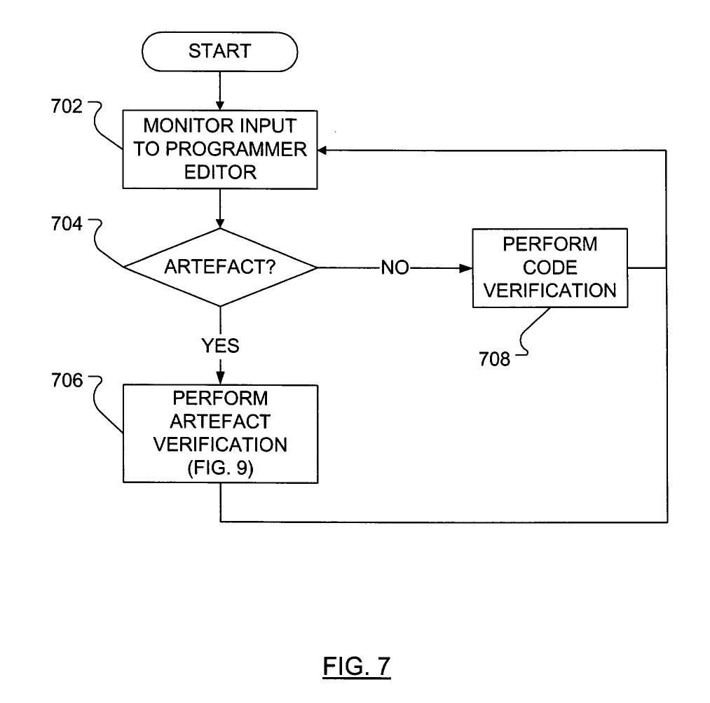

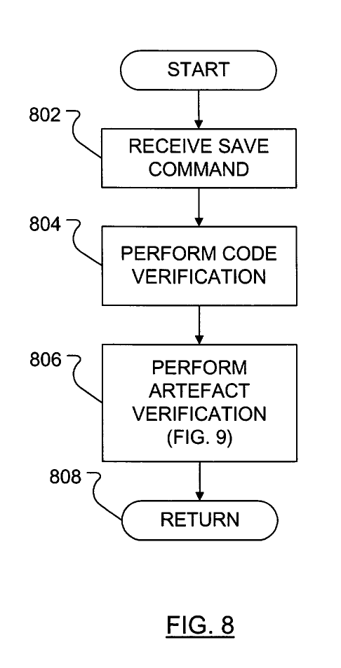

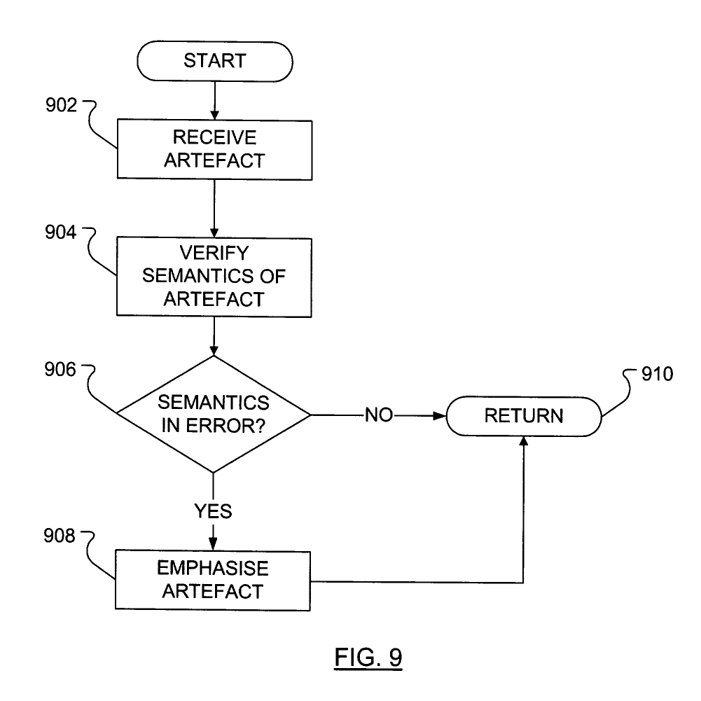

As described above, in a first aspect of the present invention, the semantic verification of supporting programming artefacts may be performed as text is being entered in a programming editor while, in a second aspect of the present invention, the semantic verification of supporting programming artefacts may be performed on an entire source file responsive to the file being saved in the programming editor. FIG. 7 illustrates an exemplary flow diagram illustrating the first aspect and FIG. 8 illustrates an exemplary flow diagram illustrating the second aspect. Common to both aspects is semantic verification, an exemplary flow diagram of which is illustrated in FIG. 9.

In FIG. 7, a flow diagram illustrates a scenario in which semantic verification of supporting programming artefacts may be required. While monitoring text input (step 702) a programming editor may determine whether the text input is program code or artefact (step 704). Where the text input is artefact, semantic verification (FIG. 9) may be performed on the artefact. The monitoring then continues (step 702). Where the text input is a portion of program code, semantic verification may be performed on the program code portion (step 708). The semantic verification of the program code is conventional and dependent on the programming language used.

Unfortunately, there are some aspects of semantic verification of artefacts that may not be performed by a keystroke monitoring process. For instance, the feature of the semantic verification of artefacts that identifies inconsistency between documentation comments and program code requires that the semantic verification of artefacts process consider the program code in addition to the documentation comments already considered. As an example, a programmer may insert a method in the program code, where the method has a parameter. The programmer may then insert documentation about the method, including the type of the parameter in the documentation. As the keystroke monitoring aspect of the semantic verification of artefacts process has ignored the entry of the program code, the semantic verification of artefacts process may not compare the type of the parameter as described in the documentation to the type of the same parameter as declared in the program code. The feature of the semantic verification of artefacts that identifies inconsistency between documentation comments and program code may be implemented in the save-based semantic verification of artefacts illustrated in FIG. 8.

In FIG. 8, a flow diagram illustrates a further scenario in which semantic verification of supporting programming artefacts may be required. Receipt of a “save” command (step 802) will, as is conventional, cause a programmer editor to save the edited text to a source file. Additionally, the receipt of the save command (step 802) can trigger a review of the edited text by features of the programmer editor. Such a review of the edited text may include, as is conventional, a program code verification (step 804). In addition to the program code verification (step 804), review of the edited text may include the semantic verification supporting programming artefacts (FIG. 9) described herein (step 806). Once both verification processes are complete, program control may be returned (step 808) to the calling process.

Since the semantic verification of artefacts process (step 806) has access to the entire file, program code may be reviewed in addition to the artefacts. As such, the feature of the semantic verification of artefacts that identifies inconsistency between documentation comments and program code may be employed. The semantic verification of artefacts process may include determining that a particular artefact is related to a particular unit of program code. Continuing the example described hereinbefore, the semantic verification may also include comparing the type of a parameter as described in the documentation to the type of the same parameter as declared in the related unit of program code.

FIG. 9 illustrates a simplified flow diagram representative of semantic verification of supporting programming artefacts. Initially, an artefact is received (step 902). Dependent upon the nature of the process that calls the process of FIG. 9, where the nature may be the keystroke-based as in FIG. 7 or save-based as in FIG. 8, artefacts may be received, for instance, word-by-word, sentence-by-sentence, line-by-line or code-unit-by-code-unit. Though the manner in which the artefacts are received matters little, semantic verification does require that some context (i.e., surrounding words) be retained for individual words. The semantics of the received artefact are then verified (step 904). That is, a word may be checked against a dictionary in a known manner, the context of the word may be determined from surrounding words and an assessment of the grammar performed or the structure of the word may be considered (for capitalization, for instance). Spelling and grammar verification are well known processes of word processing systems and it is assumed that a person skilled in the art to which the present invention pertains will have access to suitable such processes when considering adding a feature exemplary of the present invention to a programmer editor. The semantic verification of step 904 may also include a consistency check between documentation and program code as described hereinbefore. Where the semantic verification of step 904 includes a structural verification, for instance, verifying that the format of a telephone number follows a particular policy, the policy may be provided to the semantic verification process in the form of an external resource file. Such an external resource file may also be used to supplement a standard dictionary with words that would not be found in the standard dictionary.

Where, in step 904, the semantics of the artefact are found to be in error (step 906), the artefact is emphasised in the editor (step 908). As discussed hereinbefore, the emphasis may include, as illustrated in FIG. 4, a “squiggle” and an indication (e.g., warning icon 402) in the margin of the editor window. After emphasizing the error, the artefact verification is complete and program control may be returned (step 910) to the calling process. Where, in step 904, the semantics of the artefact are not found to be in error (step 906), program control may be returned (step 910) to the calling process.

Advantageously, the use of a semantic verification of supporting programming artefacts feature in programmer editors can lead to better synchronization between program code and documentation comments, a reduction in spelling and grammatical errors in program documentation and output messages, and an enforcement of company-wide format policy for documentation and output.

Supporting programming artefacts can be recognized by an editor by the manner in which they are set off from program code. For example, as will be apparent to a person skilled in the art, delimiters of documentation comments may be “// . . . ” and “/* . . . */” or the delimiters used in conjunction with the Javadoc tool, “/** . . . */”. Additionally, output messages may be recognized through their conventional enclosure by “double quote” delimiters (“. . . ”). Furthermore, a semantic verification of supporting programming artefacts feature can be extended to work on resource property files used for the purpose of the internationalization and localization.

Other modifications will be apparent to those skilled in the art and, therefore, the invention is defined in the claims.

The embodiments of the invention in which an exclusive property or privilege is claimed are defined as follows:

1. A method of providing a semantic verification feature in an editor for program code comprising:
recognizing a supporting programming artefact;
verifying semantics of said supporting programming artefact; and
where said semantics of said supporting programming artefact are in error, emphasizing a display of said supporting programming artefact.

2. The method of claim 1 wherein said emphasizing comprises underscoring a display of said supporting programming artefact with a squiggle.

3. The method of claim 2 further comprising, where said editor for program code is displayed in a window in a windowing environment, further emphasizing said supporting programming artefact, where said further emphasizing comprises displaying an icon in a margin of said window displaying said program code.

4. The method of claim 3 wherein said further emphasizing is responsive to a saving of said program code to a source file.

5. The method of claim 3 further comprising:
determining a class of said error in said semantics of said supporting programming artefact;
determining a correspondence between said class of said error and a severity condition; and
assigning a visual appearance to said icon based on said severity condition.

6. The method of claim 5 wherein said class of said error corresponds to a low severity condition and said visual appearance of said icon relates to a warning.

7. The method of claim 5 wherein said class of said error corresponds to a high severity condition and said visual appearance of said icon relates to an error.

8. The method of claim 1 wherein said error in said semantics of said supporting programming artefact is a spelling error.

9. The method of claim 1 wherein said error in said semantics of said supporting programming artefact is a grammatical error.

10. The method of claim 1 wherein said error in said semantics of said supporting programming artefact is a structural error.

11. The method of claim 1 wherein said error in said semantics of said supporting programming artefact is an inconsistency between documentation comments and program code.

12. A software development tool comprising a program code editor with a semantic verification feature operable to:
recognize a supporting programming artefact;
verify semantics of said supporting programming artefact; and
where said semantics of said supporting programming artefact are in error, emphasize a display of said supporting programming artefact.

13. A system for software development comprising a processor adapted to:
recognize a supporting programming artefact;
verify semantics of said supporting programming artefact; and
where said semantics of said supporting programming artefact are in error, emphasize a display of said supporting programming artefact.

14. A computer readable medium containing computer-executable instructions which, when performed by a processor in a computer system for software development, cause the computer system to:
present a program code editor having a semantic verification feature operable to:
recognize a supporting programming artefact;
verify semantics of said supporting programming artefact; and
where said semantics of said supporting programming artefact are in error, emphasize a display of said supporting programming artefact.

15. A method of operating a program code editor comprising:
receiving an instruction to save a text file containing program code and supporting programming artefacts; and
responsive to receiving said instruction, initiating a semantic verification of said supporting programming artefacts.

16. The method of claim 15 wherein said semantic verification of said supporting programming artefacts comprises:
recognizing said supporting programming artefacts;
verifying semantics of said supporting programming artefacts; and
where said semantics of said supporting programming artefacts are in error, emphasizing a display of said supporting programming artefacts.
